(19) United States
(12) Patent Application Publication
(10) Pub. No.: US 2011/0151735 A1
(43) Pub. Date: Jun. 23, 2011

(54) INDUSTRIAL FABRIC WITH TRACTION COATING

(76) Inventor: William Harwood, Waycross, GA (US)

(21) Appl. No.: 12/646,171

(22) Filed: Dec. 23, 2009

(51) Int. Cl. B32B 25/20; B31F 1/00

(52) U.S. Cl. 442/101; 156/459

(57) ABSTRACT

An industrial fabric used in the manufacture or processing of at least one material web includes a base fabric having a board side and a machine side. The base fabric includes a plurality of spirals extending in a cross machine direction (CMD). The spirals are interconnected together with each other along adjacent peripheral edges to form a spiral link fabric. The base fabric has opposite lateral side edges extending in a machine direction (MD). One or more electrostatic control yarns are positioned within a corresponding spiral and extend in the CMD direction to the lateral side edges. A pair of conductive edge coatings is applied to at least the board side of a respective lateral side edge for a predetermined width. The conductive edge coatings and the one or more electrostatic control yarns form an electrostatic grid. A traction coating covers substantially all of at least the board side of the base fabric, but does not cover the pair of conductive edge coatings. The traction coating has a coefficient of friction greater than approximately 2 on the board side. The industrial fabric has a completely non-marking seam because of its integral nature with the base fabric and the equal amount of traction coating at the seam compared with rest of the fabric.

### BACKGROUND OF THE INVENTION

1. Field of the Invention

The present invention relates to papermaking, and relates more specifically to corrugator “bottom belt” fabrics employed in making corrugated paper board, or box-board on a double-backer boxboard machine.

2. Description of the Related Art

During the fabrication and use of most fabrics manufactured with monofilament yarns, static electricity can build-up. The result of static electricity build-up is the occasional spontaneous electrostatic discharge (ESD). An ESD can not only damage the paper constructed product in production, but also irreparably damage the fabric used in the fabrication of the paper constructed product. This can lead to costly replacement of the fabric and down time for the manufacturing apparatus. In the worst case scenario, the machine fabricating the paper constructed product can be damaged, or initiation of a fire could result.

An example of a type of product which may be produced with a non-woven fabric is corrugated box-board. On a corrugator box-board machine there is a transformation from sheets of linerboard paper and corrugating medium paper into corrugated box-board. This is achieved by the application of a liquid adhesive (starch) to the three sheets of paper. This is normally formed by corrugating medium paper sandwiched between two sheets of corrugating linerboard paper and pressing together by one or more corrugator belts, woven or needled, or a combination thereof onto a series of steam-heated plates. In a typical corrugator machine, the heating zone comprises a series of steam-heated plates to dry the adhesive thereby “gluing” the paper assembly together, and the sheet of corrugated board is pulled by the corrugator belt. A plurality of weighted rollers or other roller less weight systems, such as spring loaded metals “shoes” within the endless loop formed by the corrugator belt press the corrugator belt toward the hot plates, so that the corrugator belt may pull the sheet across the hot plates under a selected amount of pressure. The weighted rollers or “shoes” ensure that the sheet will be firmly pressed against the hot plates, and that frictional forces between the corrugator belt and the sheet will be sufficiently large to enable the belt to pull the sheet. As well as this drying function, the belt must pass the corrugated box-board through the cooling section and onto the next stage.

Corrugator belts are generally woven or woven base and then needled, fabrics, each of which is fabricated to size or trimmed in the lengthwise and widthwise directions to a length and width appropriate for the corrugator machine on which it is to be installed. The ends of the fabrics are provided with a seam, so that they may be joined to one another with a pin, pintle, or cable when the corrugator belt is being installed on a corrugator machine.

Contemporary fabrics are produced either by being woven or needled and joined at the seam with metal clipper hooks to form an endless loop on the machine. These metal hooks are not an integral part of the corrugator belt and this can create several problems. The biggest problem can be marking of the boxboard being produced especially on boxboard constructed with e-flute or finer corrugating medium. This marking causes considerable waste and/or subsequent printing problems. Other problems caused by the metal hooks can be the fracture of the clipper hooks and mechanical wear and the subsequent damage to the corrugator machine components resulting from the clipper hooks themselves. The woven or needled felt that accommodates these clipper hooks is required to be quite dense to anchor these clipper hooks adequately. Because these materials are so dense they are consequently very low in permeability which prevents steam vapor from passing through the corrugator belt material. This, in turn slows down the bonding process and therefore the speed of the corrugator machine. These metal hooks are not an integral part of the corrugator belt and therefore need to be covered with a flap or fibers and this can create several problems. The biggest problem can be marking of the boxboard being produced especially on boxboard constructed with e-flute or finer corrugating medium.

As implied above, a corrugator belt takes the form of an endless loop when installed on a corrugator machine. In such form, the corrugator belt has a face, or board side, which is the outside of the endless loop, and a machine side, which is the inside of the endless loop. Frictional forces between the machine side of the belt and the drive rolls of the corrugator machine move the corrugator belt, while frictional forces between the face side of the top and bottom corrugator belts pull the corrugated boxboard sheet through the machine and onto the next process.

Corrugator belts should be strong and durable, and should have good dimensional stability under the conditions of tension and high temperature encountered on the machine. The belts must also be comparatively flexible in the longitudinal, or machine, direction, while having sufficient rigidity in the cross-machine direction to enable them to be guided around their endless paths.

### SUMMARY OF THE INVENTION

The present invention provides a fabric including a spiral base fabric wherein the fabric comprises a non-marking spiral seam integrated with the body of the fabric, i.e., the seam and the base fabric are essentially the same. The base fabric incorporates conductive yarns and the edges are coated for 1″ with conductive adhesive to complete the conductive grid. Furthermore, silicon is custom coated on the board side (between the 1″ conductive edges). The silicon coating extends above the base fabric approximately 2 to 6 mm and is soft and supple yet hard wearing. The silicon also helps pull the board through the machine at start-ups and after board breaks.

The invention in one form is directed to a monofilament base fabric incorporating conductive yarns and conductive edging, to complete the conductive grid. This fabric can provide one or more of the following advantages: heat and hydrolysis resistant materials, providing light weight high strength, and a surface with a high coefficient of friction due to the silicon coating. The present invention also relates to an integrated spiral loop seam integrated with the base fabric which can provide one or more of the following advantages: be an extremely stable and yet flexible corrugator fabric, with superior heat and hydrolysis resistance and the ability to provide a non-marking loop seam, and board pulling power due to the silicon coating. The base fabric is a conductive spiral fabric that is coated on the board side with a silicon rubber compound. This provides the high traction (high coefficient of friction) required. This characteristic is desired in a corrugator belt to pull the corrugated boxboard through the machine without any slippage. The non-marking seam is another desirable feature that this belt possesses. Further, because of the base structure, if the fabric is damaged in use then that particular damaged section can be removed and the fabric joined back together again and production is resumed relatively quickly. The conductive nature of the base fabric is required to prevent “shocking” of nearby personnel and also prevents fires that can be easily ignited in this environment with an electronic spark. This lighter weight design also requires less amperage from the drive motor which is additional energy savings. Also, the monofilament/silicon structure requires less cleaning because it repels the starch that is prevalent during the manufacture of boxboard. This is also an economic advantage over traditional belts.

The invention in another form is directed to an industrial fabric used in the manufacture or processing of at least one material web. The industrial fabric includes a base fabric having a board side and a machine side. The base fabric includes a plurality of spirals extending in a cross machine direction (CMD). The spirals are interconnected together with each other along adjacent peripheral edges to form a spiral link fabric. The base fabric has opposite lateral side edges extending in a machine direction (MD). One or more electrostatic control yarns are positioned within a corresponding spiral and extend in the CMD direction to the lateral side edges. A pair of conductive edge coatings is applied to at least the board side and machine side of a respective lateral side edge for a predetermined width. The conductive edge coatings and the one or more electrostatic control yarns form an electrostatic grid. A traction coating covers substantially all of at least the board side of the base fabric, but does not cover the pair of conductive edge coatings. The traction coating has a coefficient of friction greater than approximately 2 on the board side.

In view of the description noted above, the corrugator belt of the present invention possesses certain features such as strength, durability, dimensionally stable, and has a non-marking seam under all the conditions of high temperature steam, plus high tension. Furthermore, the belts are flexible in the machine direction yet sufficiently stable in the cross machine direction so as to maintain close to the belt's original dimensions and facilitate the ability to be guided along its passage around the machine under the conditions described. Also, a non-marking seam, of the same caliper of the base fabric is desired, as in this case. On the very edge, conductive adhesive such as F-611 from Plastidip is applied to form the conductive grid with the conductive yarns in the center of the spirals.

### BRIEF DESCRIPTION OF THE DRAWINGS

The above-mentioned and other features and advantages of this invention, and the manner of attaining them, will become more apparent and the invention will be better understood by reference to the following description of an embodiment of the invention taken in conjunction with the accompanying drawings, wherein:

FIG. 1 is a fragmentary, perspective view of a portion of a base fabric which may be used with the industrial fabric of the present invention; and

FIG. 2 is a schematic, perspective view of an embodiment of the industrial fabric of the present invention.

Corresponding reference characters indicate corresponding parts throughout the several views. The exemplification set out herein illustrates an embodiment of the invention, in one form, and such exemplification is not to be construed as limiting the scope of the invention in any manner.

### DETAILED DESCRIPTION OF THE INVENTION

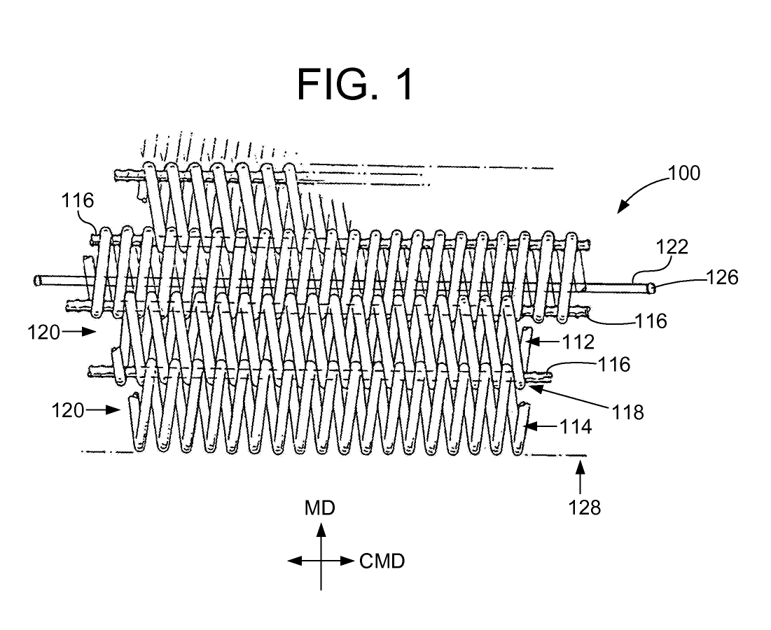

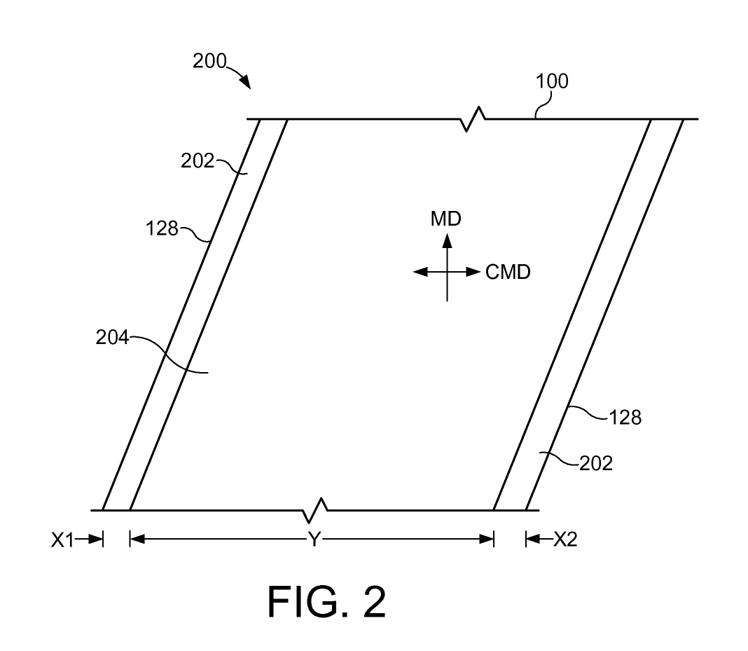

Referring now to the drawings, and more particularly to FIG. 1, there is shown a plan view of a portion of a spiral link base fabric 100 which may be used with the industrial fabric 200 (FIG. 2) according to the present invention. The basic construct of the base fabric 100 shown in FIG. 1 is likewise shown in FIG. 2 of U.S. Pat. No. 7,425,364 (Harwood et al.), which is assigned to the assignee of the present invention and incorporated herein by reference. Preliminarily, it is noted that while the discussion of the present invention may refer specifically to corrugator belts, the present invention has applicability to other fabrics in the industrial textile and other industrial applications.

Base fabric 100 includes a plurality of spirals (or coils) 112, 114 extending in a cross machine direction (CMD). Spirals 112, 114 have opposite longitudinal ends defining respective lateral side edges 128 extending in a machine direction (MD) of base fabric 100. (It should be appreciated that spirals 112, 114 are shown in fragmentary form in FIG. 1, and side edges 128 are better seen in FIG. 2). The plurality of spirals 112, 114 may be comprised of a suitable material, such as a monofilament polyester, or more specifically polyethylene terephthalate (PET), polyetheretherketone (PEEK), polyphenylene sulfide (PPS) or thermoplastic copolyesters (PCTA).

Spirals 112, 114 are made of filaments having a diameter of between approximately 0.50 mm to 1.00 mm. Spirals 112, 114 are interconnected together with each other along adjacent peripheral edges to form a spiral link fabric. More particularly, spirals 112, 114 are connected by interdigitating adjacent spirals and inserting a connecting pin (or pintle) 116 into the indigitated region 118. An open channel 120 is thereby created between the connecting rods 116 within each spiral 112, 114. Connecting pins may have a diameter, e.g., of between approximately 0.50 mm to 1.00 mm.

The open channel, or region 120 located between the connecting rods 116 may be stuffed with at least one antistatic control yarn 122. This at least one antistatic control yarn 122 is removably attached to the spiral link fabric 100. The at least one antistatic control yarn 122 can be a conductive monofilament, a conductive multifilament, a conductive metal, a conductive foam, and/or any other conductive stuffer that can be placed in one of the open channels. In one embodiment, the antistatic control yarn 122 is a carbon impregnated polyamide.

When the at least one antistatic control yarn 122 is a monofilament, it may have a diameter between approximately 0.1 mm to approximately 1.0 mm, preferably between approximately 0.28 mm to 0.90 mm, and more preferably approximately 0.52 mm. When the at least one antistatic control yarn 122 is a multifilament, it may have a diameter ranging between approximately 22 dTex and approximately 1500 dTex. Still further, the cross section of the antistatic control yarn 122 can be either a round cross section or a profiled cross section. A profiled cross section is any geometric shape that is not round or circular. For example, a profiled cross section can be oval, square, diamond or polygonal. When a plurality of the antistatic control yarns 122 are used, these antistatic control yarns 122 are preferably regularly spaced among the open channels 120 in the base fabric 100.

In contrast with the base fabric 100 shown in FIG. 2 of U.S. Pat. No. 7,425,364, it is not anticipated that further permeability control yarns 124 will be needed to control the permeability of base fabric 100. This is because the base fabric is coated and has an after-coated permeability of 0 (zero) CFM, as described more fully below. The pre-coated permeability is selected so as to allow the coating(s) to sufficiently penetrate into and/or through the base fabric 100. However, for certain applications, it may be desirable to use permeability control yarns as disclosed in U.S. Pat. No. 7,425,364.

Referring now to FIG. 2, industrial fabric 200 includes a conductive edge coating 202 which is applied to each lateral side edge 128 and connects the opposite ends 126 of the antistatic control yarns 122 with the longitudinal ends of the helical spirals 112, 114. The conductive edge coating 202 acts as a bus bar, electrically connecting the one or more antistatic control yarns 112, 114 to form a conductive grid, thereby dissipating any ESD. The conductive edge coating 202 can be an adhesive that bonds the ends of the antistatic control yarns 122 with the longitudinal ends of the spirals 112, 114 of base fabric 100. This adhesive can be, for example, a carbon impregnated adhesive. The coating or adhesive, in one embodiment, is made from a conductive carbon impregnated synthetic compound, such as carbon particles suspended in latex.

Conductive edge coating 202 is applied at least to the board side of the base fabric 100, but can also be applied to the machine side of the base fabric too, depending upon the application. Conductive edge coating 202 is applied to base fabric 100 for a predetermined width. In one embodiment, each conductive edge coating 202 is applied to base fabric 100 with a common width of 1 inch, represented by the references symbols X1 and X2, but could have a different width, depending on the application. Further, the dimensions for X1 and X2 can be the same as shown, or can be different from each other, depending on the application.

The terms “board” side and “machine” side, as used herein and known in the art, are intended to mean the side of the base fabric which carries the material web and the side that contacts the machine, respectively. Other terms such as “paper” side or “web” side, etc are also known in the art and considered synonymous terms for the board side.

Base fabric 100 also includes a traction coating 204. Traction coating 204 is applied to an area adjacent and between the conductive edge coatings 202, represented by the reference symbol Y. Traction coating 204 extends beyond the board side of the base fabric a predetermined distance (i.e., above the board side of the base fabric when the industrial fabric 200 is used as a bottom belt on double-backer boxboard corrugator machine). This allows the traction coating 204 to wear over time without industrial fabric 200 having to be replaced too often. In the illustrated embodiment, traction coating 204 has the following physical properties:

a coefficient of friction greater than approximately 2 on the board side, and greater than approximately 0.15 on the machine side (if applied to the machine side),

a thickness extending above the board side of the base fabric a distance of between approximately 2 to 6 mm (and extending through the base fabric to the machine side),

a hardness of between approximately 50 to 66 Shore A Durometer Hardness, preferably approximately 58 Shore A Hardness,

a tensile strength of between approximately 130 to 150 N/mm², preferably approximately 140 N/mm²,

approximately 220% elongation @ break,

a temperature range of between approximately +204° C. to −60° C., and

a tear strength of between approximately 14 to 18 N/mm², preferably approximately 16 N/mm².

From the foregoing, it maybe be observed that an important physical characteristic of traction coating 204 is a relatively high coefficient of friction which allows industrial fabric 200 to pull the board through the corrugator boxboard machine. In one embodiment, traction coating 204 is a rubber, preferably a silicon rubber, with the above mentioned physical properties. However, traction coating 204 could be a different type of coating material with the aforementioned physical properties.

Base fabric 100 has a pre-coated permeability of between approximately 500 to 1200 cubic feet per minute (CFM), prior to installation of antistatic control yarns 122. Preferably, base fabric 100 has a pre-coated permeability of between approximately 900 to 1200 CFM, prior to installation of antistatic control yarns 122. The permeability of industrial fabric 200 can be reduced depending on the selected diameter of the antistatic control yarns 122 to reduce the permeability of the base fabric to between, e.g., approximately 50 to 500 CFM, and in one embodiment to approximately 500 CFM. A pre-coated permeability in the range of 50 to 500 CFM is sufficient to allow the conductive edge coatings 202 and the traction coating 204 to penetrate sufficiently into base fabric 100.

### Example 1

A non-woven fabric was manufactured for a corrugator machine and was constructed using a 0.90 mm diameter polyester spiral and 0.90 mm diameter hinge pin. It was stretched and heat set at 48 pli and 210° C. After that it was measured, and electrostatic control yarns of 0.52 mm diameter (nylon impregnated with carbon) were inserted into the spirals. The fabric was cut to finished size for the customer's corrugator machine, and then edge coated for 1″ on each lateral edge with a conductive edge coating in the form of a conductive carbon impregnated synthetic rubber. A traction coating of silicon was applied to the area adjacent and between the conductive edge coatings, covering the remainder of the base fabric and extending above the base fabric a distance of approximately 2 to 6 mm. The silicon rubber compound was then heat cured at 175° C. at 48 pli.

It is noted that the foregoing example has been provided merely for the purpose of explanation and are in no way to be construed as limiting of the present invention. While this invention has been described with respect to at least one embodiment, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. A. An industrial fabric used in the manufacture or processing of at least one material web, said industrial fabric comprising:
a base fabric having a board side and a machine side, said base fabric including a plurality of spirals extending in a cross machine direction (CMD), said spirals being interconnected together with each other along adjacent peripheral edges to form a spiral link fabric, said base fabric having opposite lateral side edges extending in a machine direction (MD);
at least one electrostatic control yarn, each said electrostatic control yarn being positioned within a corresponding said spiral and extending in the CMD direction to said lateral side edges;
a pair of conductive edge coatings, each said conductive edge coating applied to at least said board side and machine side of a respective said lateral side edge for a predetermined width, said conductive edge coatings and said at least one electrostatic control yarn forming an electrostatic grid; and
a traction coating covering substantially all of at least said board side of said base fabric, except not covering said pair of conductive edge coatings, said traction coating having a coefficient of friction greater than approximately 2 on said board side.

2. The industrial fabric of claim 1, wherein said traction coating extends beyond the board side of said base fabric a distance of between approximately 2 to 6 mm.

3. The industrial fabric of claim 2, wherein said traction coating is substantially flush with the machine said of said base fabric.

4. The industrial fabric of claim 2, wherein said base fabric has a caliper of between approximately 1 to 8 mm, and said traction coating has a total thickness of approximately 3 to 14 mm.

5. The industrial fabric of claim 4, wherein said base fabric has a caliper of between approximately 1 to 4 mm.

6. The industrial fabric of claim 1, wherein said traction coating is also wear resistant with a hardness of between approximately 50 to 66 Shore A Hardness.

7. The industrial fabric of claim 1, wherein said traction coating is a rubber.

8. The industrial fabric of claim 7, wherein said rubber is a silicon rubber.

9. The industrial fabric of claim 1, wherein said traction coating has a tensile strength of between approximately 130 to 150 N/mm², approximately 220% elongation @ break, an operating temperature range of between approximately +204° C. to −60° C., and a tear strength of between approximately 14 to 18 N/mm².

10. The industrial fabric of claim 9, wherein said traction coating has a hardness of approximately 58 Shore A Hardness, a tensile strength of approximately 140 N/mm², and a tear strength of approximately 16 N/mm².

11. The industrial fabric of claim 12, wherein said base fabric has a pre-coated permeability of between approximately 50 to 500 cubic feet per minute (CFM), and a permeability of 0 (zero) after said pair of conductive edge coatings and said traction coating are applied.

12. The industrial fabric of claim 11, wherein said pre-coated permeability of said base fabric is after said antistatic control yarns are installed in said base fabric.

13. The industrial fabric of claim 1, wherein said traction coating is also applied to said machine side of said base fabric.

14. The industrial fabric of claim 13, wherein said traction coating has a coefficient of friction greater than approximately 0.15 on said machine side.

15. The industrial fabric of claim 1, wherein said spirals are monofilament polyester spirals lying adjacent each other in the MD direction, said spirals being interconnected to each other with a plurality of connecting pins extending in the CMD direction.

16. The industrial fabric of claim 15, wherein said spirals include filaments with a diameter of between approximately 0.50 mm to 1.00 mm.

17. The industrial fabric of claim 15, wherein the connecting pins have a diameter of between approximately 0.50 mm to 1.00 mm

18. The industrial fabric of claim 1, wherein each said antistatic control yarn is comprised of nylon impregnated with carbon.

19. The industrial fabric of claim 18, wherein each said antistatic control yarn has a diameter of between approximately 0.28 mm to 0.90 mm.

20. The industrial fabric of claim 19, wherein each said antistatic control yarn has a diameter of approximately 0.52 mm.

21. The industrial fabric of claim 1, wherein each said conductive edge coating is comprised of a conductive carbon impregnated synthetic compound with a width of approximately 1 inch in the CMD direction.

22. The industrial fabric of claim 1, wherein said plurality of spirals are a monofilament comprised of one of polyethylene terephthalate (PET), polyetheretherketone (PEEK), polyphenylene sulfide (PPS) or thermoplastic copolyesters (PCTA).

23. The industrial fabric of claim 1, wherein said base fabric includes a seam extending in the CMD direction, and said seam has a caliper which is the same as a pre-coated caliper of said base fabric.

24. A corrugator boxboard machine, including a top corrugator belt and a bottom corrugator belt, said bottom corrugator belt comprising:
a base fabric having a board side and a machine side, said base fabric including a plurality of spirals extending in a cross machine direction (CMD), said spirals being interconnected together with each other along adjacent peripheral edges to form a spiral link fabric, said base fabric having opposite lateral side edges extending in a machine direction (MD);
at least one electrostatic control yarn, each said electrostatic control yarn being positioned within a corresponding said spiral and extending in the CMD direction to said lateral side edges;
a pair of conductive edge coatings, each said conductive edge coating applied to at least said board side of a respective said lateral side edge for a predetermined width, said conductive edge coatings and said at least one electrostatic control yarn forming an electrostatic grid; and
a traction coating covering substantially all of at least said board side of said base fabric, except not covering said pair of conductive edge coatings, said traction coating having a coefficient of friction greater than approximately 2 on said board side.

25. The corrugator boxboard machine of claim 24, wherein said traction coating extends beyond the board side of said base fabric a distance of between approximately 2 to 6 mm.

26. The corrugator boxboard machine of claim 25, wherein said traction coating is substantially flush with the machine said of said base fabric.

27. The corrugator boxboard machine of claim 25, wherein said base fabric has a caliper of between approximately 1 to 8 mm, and said traction coating has a total thickness of approximately 3 to 14 mm.

28. The corrugator boxboard machine of claim 27, wherein said base fabric has a caliper of between approximately 1 to 4 mm.

29. The corrugator boxboard machine of claim 24, wherein said traction coating is also wear resistant with a hardness of between approximately 50 to 66 Shore A Hardness.

30. The corrugator boxboard machine of claim 24, wherein said traction coating is a rubber.

31. The corrugator boxboard machine of claim 30, wherein said rubber is a silicon rubber.

32. The corrugator boxboard machine of claim 24, wherein said base fabric has a pre-coated permeability of between approximately 50 to 500 cubic feet per minute (CFM), and a permeability of 0 (zero) after said pair of conductive edge coatings and said traction coating are applied.

33. The corrugator boxboard machine of claim 32, wherein said pre-coated permeability of said base fabric is after said antistatic control yarns are installed in said base fabric.

34. The corrugator boxboard machine of claim 24, wherein said traction coating is also applied to said machine side of said base fabric.

35. The corrugator boxboard machine of claim 34, wherein said traction coating has a coefficient of friction greater than approximately 0.15 on said machine side.
